(19) United States
(12) Patent Application Publication
(10) Pub. No.: US 2010/0094855 A1
(43) Pub. Date: Apr. 15, 2010

(54) SYSTEM FOR TRANSFORMING QUERIES USING OBJECT IDENTIFICATION

(76) Inventor: Omid Rouhani-Kalleh, Santa Clara, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/394,930

(22) Filed: Feb. 27, 2009

Related U.S. Application Data
(63) Continuation-in-part of application No. 12/251,146, filed on Oct. 14, 2008.

(51) Int. Cl. G06F 17/30

(52) U.S. Cl. 707/706; 707/E17.014; 707/E17.044

(57) ABSTRACT

A system and method is provided for rewriting a query sent from a user to a search provider. The search provider displays results from content providers through modules associated with the content providers. The search provider predicts whether the query would be successful for one or more modules using information about keywords that have been tested on the module. The search provider attempts to replace a query predicted to not be successful for the module by searching for the query in a list of aliases. Each list in the list of aliases is associated with an object identifier. Each object identifier identifies a real-world object or entity to which the object identifier refers. If the query is found in a list of aliases, the search provider selects another keyword from the list. The search provider sends the selected keyword, instead of the query, to the module.

### CROSS-REFERENCE TO RELATED APPLICATIONS; BENEFIT CLAIM

This application claims benefit as a Continuation-in-part of application Ser. No. 12/251,146, filed Oct. 14, 2008, the entire contents of which is hereby incorporated by reference as if fully set forth herein, under 35 U.S.C. §120. The applicant hereby rescinds any disclaimer of claim scope in the parent application or the prosecution history thereof and advises the USPTO that the claims in this application may be broader than any claim in the parent application.

This application is related to application Ser. No. 12/371,410, filed Feb. 13, 2009, the entire contents of which are hereby incorporated by reference as if fully set forth herein. This application is also related to application Ser. No. 12/368,074, filed Feb. 9, 2009, the entire contents of which are hereby incorporated by reference as if fully set forth herein.

### FIELD OF THE INVENTION

The present invention relates to rewriting a query such that the rewritten query refers to the same object as the original query.

### BACKGROUND

Many online service providers offer search services to users. When a user submits a search query, an online service provider displays results for the query. Some online service providers, such as Yahoo, Inc., group search results based on the type of content in the search results. For example, in response to a search, the user could be presented with a group of images displayed in one region, a group of news articles displayed in another region, or both images and articles displayed in the same region.

The results may also be grouped according to the source of the content in the search results. For example, CNN® content could be displayed in one region while ESPN® content is displayed in another region. Some sources of content, or content providers, specialize in content associated with a particular topic or category. For example, ESPN® content, available at espn.com, is specialized sports content such as sports scores, sports schedules, injury reports, and other sports news. Yahoo!TV®, available at tv.yahoo.com, provides TV listings and other content related to TV shows, including several full episodes. CNN®, available at cnn.com, provides breaking news in several news categories.

The content providers generate content based on keywords. For example, the keyword “Britney Spears” may cause a news content provider to generate news content about Britney Spears. However, the same keyword may not generate any results for a content provider specializing in sports news. Similarly, a keyword such as “YHOO,” the ticker symbol for Yahoo, Inc., may not generate results for most content providers, but the keyword would cause a finance content provider, such as Yahoo! Finance, to generate news about Yahoo, Inc. Many content providers can understand the keywords “Yahoo” and “Yahoo, Inc.” even though they cannot understand the keyword “YHOO,” which is a specialized finance term.

Online service providers can combine results from several different content providers if the user is given an opportunity to re-type unsuccessful queries. For example, a user who unsuccessfully searched for “YHOO” may re-type the query as “Yahoo” or “Yahoo, Inc.” for a better chance at meaningful search results. Similarly, a user searching on a finance content provider who received no results for “Yahoo” may re-type the query as “YHOO” to get results for the company by ticker symbol. Many times, online service providers will make suggestions to users based on various popular queries that have similar text characters to the query submitted by the user. For example, “YHOO” differs from “YAHOO” by only one character. The online service provider could display “Did you mean ‘YAHOO”’ to the user in response to receiving “YHOO.”

The user is required to make an extra decision and perform an extra input step when selecting “YAHOO” as the correct term from a list of suggested terms. Additionally, the user's query might not always be just one character away from a functional or popular keyword. For example, Sony Corporation has a ticker symbol of SNE. If the user queries SNE, then a string correction might produce any number of keywords, such as “SINE” (mathematics), “SANE” (psychology), “SNES” (Super Nintendo® Entertainment System), etc.

Online service providers need a new method for rewriting queries that preserves the intended meaning of the original query. A reliable method for rewriting queries would improve the utility of a search across several content categories. Further, users will be attracted to an online service provider with the extra capability of reliably rewriting queries to display a variety of content.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram illustrating one system for storing a keyword into a list of aliases.

FIG. 2 is a diagram illustrating one system for ordering and re-ordering sets of aliases.

FIG. 3 is a diagram illustrating one system for rewriting a query as a keyword that represents the same object as the query.

FIG. 4 is a diagram illustrating one system for rewriting a query using a list of aliases with module compatibility data.

FIG. 5 is a diagram illustrating one system for storing module compatibility data about keywords that have been attempted on a module.

FIG. 6 is a diagram illustrating a computer system that can be used to rewrite a query as a keyword that represents the same object as the query.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview of Method for Rewriting Queries

Techniques are described for rewriting a query sent from a user to a search provider. The search provider displays results from content providers through modules associated with the content providers. The search provider predicts whether the query would be successful for one or more modules based at least in part on information about keywords that were or were not accepted by the module in the past. If the search provider predicts that the query would not be successful for the module, the search provider searches for the query in a list of aliases. Each list in the list of aliases is associated with an object identifier. Each object identifier identifies a real-world object or entity to which the object identifier refers.

If the query is found in a list of aliases, the search provider selects another keyword from the list. In one embodiment, the selected keyword is a keyword that is predicted to be successful for the module. Optionally, the selected keyword is chosen based at least in part on an order of the keywords in the list. The keywords in the list may be ordered based at least in part on the popularity of the keywords in news articles and other documents. The search provider sends the selected keyword, instead of the query, to the module.

If the selected keyword is successful for the module as predicted, then the module provides content for the selected keyword. If the keyword fails to provide content, then another keyword from the list may be selected for the module. The process may be repeated until either the keywords in the list have been exhausted, or until the module provides content in response to one of the keywords.

The query rewriting technique described herein builds on concepts described in “System For Resolving Entities In Text Into Real World Objects Using Context,” U.S. application Ser. No. 12/251,146 (“parent application”), filed Oct. 14, 2008, the entire contents of which have been incorporated by reference as if fully set forth herein. The parent application describes a method for detecting an entity in text and associating that entity with a real world object identified by an object identifier. The parent application then describes how to categorize the object identifier.

### Mapping Keywords of Objects

A query is rewritten to a keyword that has been found in a list of aliases. A keyword is a string of characters, or a text, received by a user. The user is attempting to perform a search using the best query known to the user. Unfortunately, the user does not know what queries are accepted by the search engine, database, or other content provider receiving the query. If the user types a query that is not recognized by the content provider, then the user will receive either meaningless content or no content at all. In order to better serve the intent of the user, keywords that represent potential queries are mapped to objects. A query received by a search provider may be rewritten to a keyword referring to the same object if the search provider predicts that the content provider will not accept the original query.

An entity resolver maps a keyword to an object identifier that represents a real-world object or entity with a degree of confidence. In one embodiment, the object identifier is a page name, or entry name, to an informational resource such as Wikipedia®. For example, Wikipedia®, via the Wikipedia® database accessible via a Web interface, contains a page about the movie, The Dark Knight, which is an entry in an informational resource such as Wikipedia®. Collectively, the entries for the informational resource may be referred to as objects. The page about “The Dark Knight” is identified by a page identifier, or object identifier, “The_Dark_Knight_(film).” The object identifier for a keyword, such as “dark knight batman,” is determined from one or more of a number of sources. Each source is associated with object identifiers, such as “The_Dark_Knight_(film),” and queries such as “dark knight batman” in different ways. Any source that indicates an association between a keyword and an object identifier may be used to resolve the keyword into an object identifier.

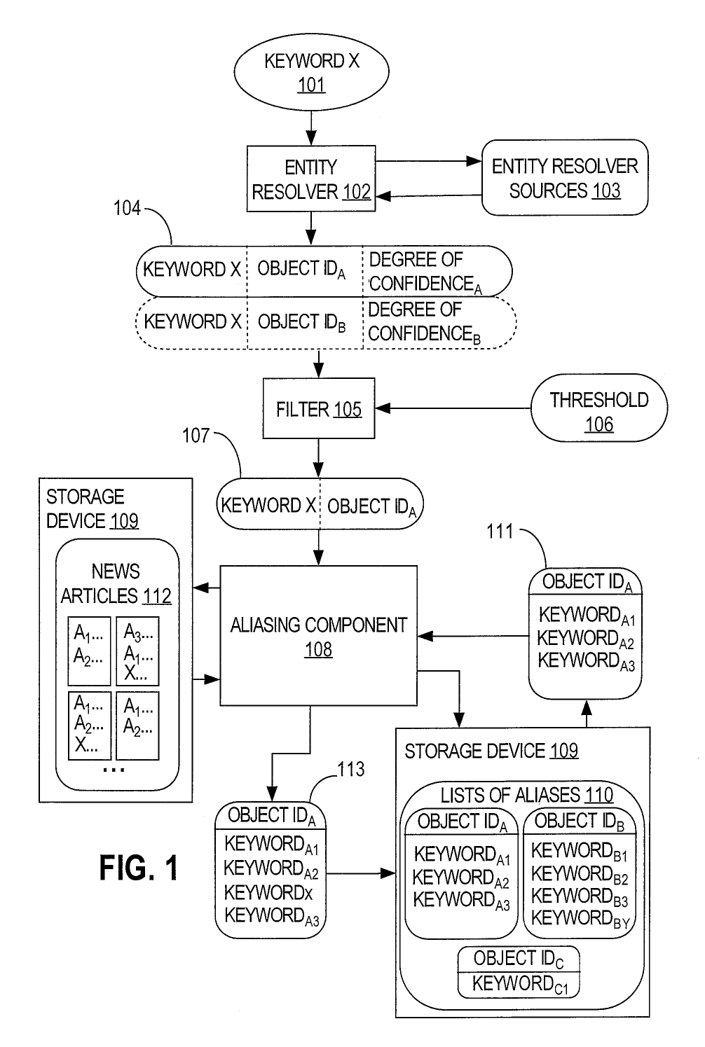

FIG. 1 shows a sample system for storing a keyword in a list of aliases. Referring to FIG. 1, a keyword 101 to be stored in the list of aliases is received by an entity resolver 102. Entity resolver 102 uses entity resolver sources 103 such as click logs, link graphs, redirect lists, disambiguation lists, and object lists to determine a set 104 that includes keyword 101, an object identifier for keyword 101, and a degree of confidence that the object identifier represents the keyword. In one embodiment, entity resolver determines that multiple object identifiers, illustrated as OBJECT ID_{A} and OBJECT ID_{B}, are associated with keyword 101.

### Using Query Logs of Map a Keyword to an Object

In one embodiment, click logs from a search engine may be used to map queries to object identifiers. Click logs show queries that users have sent, search engine results for the queries, and to which pages users navigated. For example, a users who searched for “dark knight batman” navigated to the Wikipedia® page identified as “The_Dark_Knight_(film)” 30% of the time, to the Internet Movie Database® (“IMDB®”) page identified as “tt0468569” (the movie, “The Dark Knight”) 50% of the time, and to other sites 20% of the time. Because the Wikipedia® page identified as “The_Dark_Knight_(film)” identifies the IMDB® page “tt0468569” in the “External links” section, clicks to both the IMDB® “tt0468569” page and the Wikipedia® “The_Dark_Knight_(film)” page can be attributed to the same object. For simplicity, that object can be identified using the Wikipedia ID “The_Dark_Knight_(film).” Accordingly, the click logs would show an 80% degree of confidence that a user typing “dark knight batman” refers to the object identified as “The_Dark_Knight_(film).” If the degree of confidence passes an entity-to-object threshold, then the entity text, “dark knight batman” can be mapped to the object ID “The_Dark_Knight_(film)” and stored in the list of entities.

An example of query log data is provided below in Table 1. Table 1 shows documents that have been navigated to by users who submitted queries. For example, in the first row, a user typed “Britney Spears” and navigated to www.britneyspears.com. The second and third rows are identical because two users have searched for USA and navigated to http://en.wikipedia.org/wiki/United_States. In reality there might be hundreds or thousands of entries for each link, or document clicked, in the search log. It is often more practical to store counts for how many times a Query and Document combination exist. However, the example below is provided for illustrative purposes.

TABLE 1

| Query user used | Document clicked |
|---|---|
| Britney Spears | http://www.britneyspears.com/ |
| USA | http://en.wikipedia.org/wiki/United_States |
| USA | http://en.wikipedia.org/wiki/United_States |
| Donald Duck | http://www.donaldduck.com/donald.html |
| USA | http://en.wikipedia.org/wiki/List_of_USA_Presidents |
| USA | http://en.wikipedia.org/wiki/Miss_USA |
| Britney Spears | http://en.wikipedia.org/wiki/Britney_Spears |

In one embodiment, the data is filtered to remove all entries that are not associated with Wikipedia®, as shown in Table 2 below. In Table 2, the entry for Britney Spears that refers to www.britneyspears.com, and the entry for Donald Duck that refers to www.donaldduck.com/donald.html, have been removed.

TABLE 2

| Query user used | Document clicked |
|---|---|
| USA | http://en.wikipedia.org/wiki/United_States |
| USA | http://en.wikipedia.org/wiki/United_States |
| USA | http://en.wikipedia.org/wiki/List_of_USA_Presidents |
| USA | http://en.wikipedia.org/wiki/Miss_USA |
| Britney Spears | http://en.wikipedia.org/wiki/Britney_Spears |

Next, undesirable Wikipedia® entries are filtered out, as shown in Table 3 below. In Table 3, the filter removed Wikipedia® pages that have prefixes such as “List_of_” or “Template:” or “Wikipedia:” since these do not refer to actual real world objects (such as persons, things, objects, entities, or events). The list of prefixes above is not complete, but pages that may be removed generally include lists of things or events or pages created for administrative purposes for Wikipedia®.

TABLE 3

| Query user used | Document clicked |
|---|---|
| USA | http://en.wikipedia.org/wiki/United_States |
| USA | http://en.wikipedia.org/wiki/United_States |
| USA | http://en.wikipedia.org/wiki/Miss_USA |
| Britney Spears | http://en.wikipedia.org/wiki/Britney_Spears |

Next, the probabilities that an entity refers to a particular Wikipedia® page are calculated by analyzing the query logs and calculating P(d|q). The probability that keyword “q” refers to Wikipedia page name “d” is given by the following equation:

P(d|q)=(Number of times someone clicked on “d” when searching for “q”)/ (Total number of times someone searched for “q”)

From the data above, when the entity resolver receives entity text “q” in the future, the entity resolver will know that “q” refers to Wikipedia page name “d” with probability P(d|q).

In the example above, the following probabilities, or degrees of confidence, are generated:
P(United_States|“USA”) 0.67,
P(Miss_USA|“USA”)=0.33, and
P(Britney_Spears|“Britney Spears”) 1.0.

### Using Link Graphs to Map a Keyword to an Object

The entity resolver also uses link graphs to map queries to object identifiers with degrees of confidence. Search engines use link graphs to rank pages. Pages that are most frequently linked to by other pages receive higher ranks. In the Dark Knight example, links with the anchor text, “The Dark Knight,” link to the IMDB® page identified as “tt0468569” 40% of the time, to the Rotten Tomatoes® page identified as “the_dark_knight” 30% of the time, to the Wikipedia® page identified as “The_Dark_Knight_(film)” 20% of the time, and to other pages 10% of the time. As discussed, the IMDB® page identified as “tt0468569” is associated with the Wikipedia® page identified as “The_Dark_Knight_(film)” via the “External links” section. Similarly, the Rotten Tomatoes® page identified as “the_dark_knight” is associated with the Wikipedia® page identified as “The_Dark_Knight_(film).” Accordingly, Web sites linked to information about the same Dark Knight movie 90% of the time, indicating a 90% degree of confidence that a Web site linking to “The Dark Knight” referred to the object identified as “The_Dark_Knight_(film).” In the example, the entity text, “The Dark Knight,” is mapped to object ID “The_Dark_Knight_(film).”

An example of link graph data is provided below in Table 4. Table 4 shows the text that is used in Wikipedia® pages when linking to other Wikipedia® pages.

TABLE 4

| Page with link | Where the link goes | Text on link |
|---|---|---|
| Britney_Spears | Jennifer_Lopez | JLo |
| List_of_Actresses | Jennifer_Lopez | Jennifer Lopez |
| George_Bush | List_of_USA_Presidents | list of united states |
| | | presidents |
| Sweden | Stockholm | capital of Sweden |
| Sweden | Queen_Silvia_of_Sweden | queen of Sweden |
| List_of_Movies | Orange_County_(film) | orange county |
| California | Orange_County,_California | orange county |
| Florida | Orange_County,_California | orange county |

The example link graph data is presented in three columns. The first column (“Page with link”) is not being used in the example. The second and third columns (“Where the link goes” and “Text on link”) provide the object identifier for the Wikipedia® page linked to and the text used for the link. Links to pages other than Wikipedia® pages can be filtered out to generate the data in Table 4. In Table 5, pages with prefixes such as “List_of” are filtered out. Table 5 shows the link graph data after the page linking to the Wikipedia® list “List_of_USA_Presidents” has been filtered out.

TABLE 5

| Page with link | Where the link goes | Text on link |
|---|---|---|
| Britney_Spears | Jennifer_Lopez | JLo |
| List_of_Actresses | Jennifer_Lopez | Jennifer Lopez |
| Sweden | Stockholm | capital of Sweden |
| Sweden | Queen_Silvia_of_Sweden | queen of Sweden |
| List_of_Movies | Orange_County_(film) | orange county |
| California | Orange_County,_California | orange county |
| Florida | Orange_County,_California | orange county |

The data from Table 5 is used to calculate the probability, or degree of confidence, that an entity text maps to an object identifier. The probabilities in the example are as follows, where P (X|Y) is the probability that a link text Y refers to Wikipedia® object X given that the link text Y occurs:
P(Jennifer_Lopez|“JLo”)=1.0,
P(Jennifer_Lopez|“Jennifer Lopez”)=1.0,
P(Stockholm|“capital of Sweden”)=1.0,
P(Queen_Silvia_of_Sweden|“queen of Sweden”)=1.0,
P(Orange_County_(film)|“orange county”)=0.33, and
P(Orange_County,_California|“orange county”)=0.67.

### Using Redirect Lists to Map a Keyword to an Object

Redirect lists are managed by online service providers in order to direct a user to a target page from another page. Redirect lists can also be used to map a keyword to an object identifier. For example, if the user navigates to the Wikipedia® page identified as “Dark_Knight_(film)” instead of “The_Dark_Knight_(film),” then the user is redirected by Wikipedia® to “The_Dark_Knight_(film)” based in part on the editorial management of a redirect list. Similarly, if the user navigates to “The_Dark_Knight_(movie),” the user is also directed to “The_Dark_Knight (film).” Underscores and parenthesis can be removed from the Wikipedia IDs when adding to the list of entities. For example, “Dark Knight film,” “The Dark Knight movie,” and “The Dark Knight film” can be added as entity texts that all refer to “The_Dark_Knight_(film).”

An example redirect list is provided in Table 6. The redirect list shows the Wikipedia® page navigated to by the user in the left column, followed by the Wikipedia® page the user is redirected to in the right column.

TABLE 6

| Wikipedia page | Redirects to |
|---|---|
| Elvis | Elvis_Presley |
| Elvis_Aaron_Presley | Elvis_Presley |
| Elvis_Aron_Presley | Elvis_Presley |
| The_King_of_Rock_‘n’_Roll | Elvis_Presley |
| John_Smith_(Basketball) | John_Smith |
| John_Smith_(Republican) | John_Smith_(Politician) |
| John_Smith_(NBA) | John_Smith |

As shown in Table 6, when a user attempts to visit, for example, http://en.wikipedia.org/wiki/Elvis, the user is actually redirected to http://en.wikipedia.org/wiki/Elvis_Presley. To generate probabilities, or degrees of confidence, based on the redirect lists, the information in the parentheticals for the Wikipedia® page may be ignored. For example, “John_Smith_(NBA)” is represented as “john smith” and not “john smith (nba).” The probabilities in the example are as follows, where P (X|Y) is the probability that a link text Y refers to Wikipedia® object X given that the link text Y occurs:
P(Elvis_Presley|“Elvis”)=1.0,
P(Elvis_Presley|“Elvis Aaron Presley”)=1.0,
P(Elvis_Presley|“Elvis Aron Presley”)=1.0,
P(Elvis_Presley|“The King of Rock ‘n’ Roll”)=1.0,
P(John_Smith|“John Smith”)=0.66, and
P(John_Smith_(Politician)|“John Smith”)=0.33.

### Using Disambiguation Lists to Map a Keyword to an Object

A disambiguation list can also be used to map a keyword to an object identifier. Disambiguation lists are lists of pages that are suggested to a user when the user submits a query. For example, if the user submits “Dark Knight” to Wikipedia®, then the user is provided with a disambiguation list that includes “The_Dark_Knight (film)” at the top of the list based in part on the editorial management of a disambiguation list. Accordingly, the disambiguation list indicates that entity text “Dark Knight” would map to “The_Dark_Knight_(film).”

An example disambiguation list is provided in Table 7, which shows bulleted items of the disambiguation list for “Dark Knight” on Wikipedia®.

TABLE 7

The Dark Knight (film) . . .
The Dark Knight (video game) . . .
The Dark Knight (soundtrack) . . .
Batman: The Dark Knight Returns . . .
Batman: The Dark Knight Strikes Again . . .
Batman: DarKnight . . .
The Dark Knight (roller coaster) . . .
A character class . . .
Knights of Neraka . . .
Mark Knight (sound designer) . . .

The disambiguation list may provide a degree of confidence for each bulleted item X in the disambiguation list. In one embodiment, the degree of confidence is the same for each bulleted item X. For example, the first and second item in a two-item disambiguation list may each be assigned a degree of confidence of 0.2. Alternately, the degree of confidence is based at least in part on the total number of items in the list. Specifically, each item of an n-item list may be assigned a degree of confidence of 1/n. For a two-item list, each item may be assigned a degree of confidence of ½, or 0.5.

In another embodiment, the degree of confidence is based at least in part on a score, S(X), which factors in the position of each item in the disambiguation list. For example, the list above has 10 items (n, where n is the number of items). Using a simple score assignment technique, the first item is given 10 points (n), the second item 9 points (n−1), the third item 8 points (n−2), . . . and the last item 1 point (n−(n−1)). The score is calculated by dividing the number of points assigned to an item by the total number of points assigned. Using this technique, the disambiguation list would indicate that “Dark Knight” is n times more likely to refer to the first item than the last item in a list with n items. In another embodiment, additional weight could be given to the first item. Any technique for assigning scores to the order of items in the disambiguation list can be used to generate a degree of confidence based on the disambiguation list. Example degrees of confidence, given that “Dark Knight” is used as the query, are as follows:
S(The Dark Knight (film))=10/55,
S(The Dark Knight (video game))=9/55,
S(The Dark Knight (soundtrack))=8/55,
S(Batman: The Dark Knight Returns)=7/55,
S(Batman: The Dark Knight Strikes Again)=6/55,
S(Batman: DarKnight)=5/55,
S(The Dark Knight (roller coaster))=4/55,
S(A character class)=3/55,
S(Knights of Neraka)=2/55, and
S(Mark Knight (sound designer))=1/55.

### Using Page Names to Map a Keyword to an Object

A list of object identifiers, or Wikipedia® page names, can be used to map queries to object identifiers. For example, a list of Wikipedia object identifiers includes “The_Dark_Knight_(film).” Unique substrings of the object identifier, such as “The Dark Knight,” “Dark Knight film,” and “The Dark Knight film,” can be used to generate entities for the entity list. Non-unique substrings, such as “Knight,” would not be mapped to the object identified as “The_Dark_Knight_(film).” Instead, the non-unique substring “Knight” would be mapped to the object identified as “Knight,” which better matches the substring.

Table 8 shows an example dataset of Wikipedia® page names that may be used to determine degrees of confidence.

TABLE 8
Wikipedia page name

John_Smith
John_Smith_(Politician)
George_Bush
Britney_Spears
Orange_County_(film)
Orange_County,_Florida
Orange_County,_California

The page names may be reformatted by removing underscores and parenthesis. In one embodiment, the items in the parenthesis are removed from the page names. Example probabilities, or degrees of confidence, are as follows:
P(John_Smith|“John Smith”)=0.5,
P(John_Smith_(Politician)|“John Smith”)=0.5,
P(George_Bush|“George Bush”)=1.0,
P(Britney_Spears|“Britney Spears”)=1.0,
P(Orange_County_(film)|“Orange County”)=0.33,
P(Orange_County,_Florida|“Orange County”)=0.33, and
P(Orange_County,_California|“Orange County”)=0.33.

### Combining Multiple Sources to Map a Keyword to an Object

Once the entity resolver calculates a degree of confidence from one or more of the sources described above, the entity resolver optionally weighs these probabilities according to a weight that is assigned to each source. The weight assigned to each source indicates the reliability of degrees of confidence that come from that source.

The final probability that entity text “q” refers to Wikipedia® page “d” is calculated for n entity resolver sources as follows:

P(d|q)=W₁*P₁(d|q)+W₂*P₂(d|q)+ . . .+Wₙ*Pₙ(d|q),

where Pₓ(d|q) is the probability according to component X that component X correctly predicted the object identifier, and Wₓ is a weight corresponding to the reliability of component X to provide an accurate probability. For example, if component 1 generally provides better predictions than component 2, then W₁>W₂.

One can choose many different ways to assign values to the weights Wₓ. In one embodiment, weights are set using machine learning techniques on the output of the various components. In another embodiment, the weights are chosen by hand and roughly correspond to how well the components have performed when the data is spot checked.

For example, for the term “orange county,” the entity resolver sources may produce the following probabilities:
P₁(Orange_County,_California|“orange county”)=0.8,
P₁(Orange_County,_Florida|“orange county”)=0.2,
P₂(Orange_County_(film)|“orange county”)=0.4, and
P₂(Orange_County,_California|“orange county”)=0.6.

In the example, only components 1 and 2 were used to map “orange county” to object identifiers. Other components, if present, may not have provided output for the term “orange county.” If component 1 is very reliable, but component 2 is less reliable, weights may be assigned to components 1 and 2 as follows:

W₁=0.4

W₂=0.2

The final probabilities in the example are calculated as follows:

P_{final}(Orange_County,_California|“orange county”)=0.4*0.8+0.2*0.6=0.44,

P_{final}(Orange_County,_Florida|“orange county”)=0.4*0.2 0.08,

P_{final}(Orange_County_(film)|“orange county”)=0.2*0.4=0.08.

Since the weight is strongest for Orange_County,_California, the entity resolver computes that “orange county” most likely refers to the object identified by Orange_County,_California when “orange county” is the keyword.

In the example above, there is a relatively high degree of confidence that entity text “orange county” refers to Orange_County,_California. The entity resolver may send sets of (entity text, object identifier, degree of confidence) to a filter. The filter may remove those sets with degrees of confidence below a threshold. In one embodiment, the degrees of confidence are normalized before they are filtered so that the sum of the confidence values is approximately equal to 100%, or 1. If normalized, the degree of confidences in the above example are modified as follows:

N(P_{final}(Orange_County,_California|“orange county”))= 0.44/0.6=0.73,

N(P_{final}(Orange_County,_Florida|“orange county”))= 0.08/0.6=0.13,

N(P_{final}(Orange_County_(film)|“orange county”))= 0.08/0.6=0.13.

If a threshold is set at 0.5, then the keyword “orange county” can be said to unambiguously refer to Orange_County,_California. In one embodiment, only the best (entity text, object identifier) pair is sent to the aliasing component. The best (entity text, object identifier) pair may be selected as the pair with the highest degree of confidence. Alternately, the total degree of confidence for an (entity text, object identifier) pair could be determined in a manner that ensures only one pair can receive a degree of confidence above a threshold, for example 0.5 or 0.8. In these embodiments, the list of aliases would include only unambiguous entity texts. Queries later received would be mapped to only one object. For example, “orange county” would only be mapped to “Orange_County,_California.” In the example, a query for “orange county” could be rewritten to the entity text, “Orange County, California,” or a number of other entity texts that are unambiguously associated with Orange_County,_California (i.e., “Orange County, CA,” “Orange County California,” etc.).

A second threshold may be used to ensure that highly infrequent pairs of (entity text, object identifier) do not receive a high weight resulting primarily from normalization. For example, the entity resolver may determine that one or more components were used to determine that “amazzzon” refers to “Amazon_River” 0.01% of the time and “Amazon_Rainforest” 1.00% of the time. If these values are normalized, the entity resolver would output that “amazzzon” refers to “Amazon_River” 0.99% of the time and “Amazon_Rainforest” 99.01% of the time. Although the normalized probability would likely exceed any threshold, the pre-normalized probability is so low that a mapping from “amazzzon” to “Amazon Rainforest” would be unreliable. Accordingly, the pre-normalized degrees of confidence may be compared to a second threshold to determine whether to use the data for mapping purposes.

In the example, “amazzzon” would not get mapped to “Amazon_Rainforest” despite the fact that the normalized degree of confidence (99.01%) is higher than a first threshold of, for example, 80%, because the pre-normalized degree of confidence (1.00%) is lower than a second threshold of, for example, 10%.

In another example, the entity resolver predicts several object identifiers, each with a degree of confidence that is relatively high. If none of the degrees of confidence is above a first threshold, for example 50%, after normalization, then the entity text can be said to be ambiguous. In one embodiment, ambiguous entity texts that cannot be filtered down to one object identifier are disregarded. In other words, the entity texts are not stored in the lists of aliases. Upon receiving an ambiguous query, the online service provider sends the ambiguous query as is to the module without attempting to rewrite the query.

In another embodiment, ambiguous entity texts along with the associated object identifiers are sent to an aliasing component to be included in the list of aliases. The list of aliases could include ambiguous entity texts as well as unambiguous entity texts. In this case, queries later received would occasionally be mapped to more than one object. For example, “orange county” may be mapped to “Orange_County,_Florida,” “Orange_County_(film),” and “Orange_County,_California.” In the example, a query for “orange county” could be rewritten to three separate queries, one of which refers to the object “Orange_County,_Florida,” one of which refers to the object “Orange_County_(film),” and one of which refers to the object “Orange_County,_California.”

For illustrative purposes, FIG. 1 shows lists of aliases formed from unambiguous keywords. Sets including keyword 101, an object identifier, and a degree of confidence are sent from entity resolver 102 to filter 105. Filter 105 uses threshold 106 to determine whether any of the object identifiers are sufficiently associated with keyword 101. As shown, OBJECT IDA is associated with keyword 101 to DEGREE OF CONFIDENCE_{A}, for example 80%. OBJECT IDB is associated with keyword 101 to DEGREE OF CONFIDENCE_{B}, for example 10%. A threshold of 50% filters out OBJECT IDB, which only has a degree of confidence of 10%. Filter 105 passes the acceptable pair of keyword 101 and OBJECT IDA to aliasing component 108.

### Generating Sets of Aliases

The aliasing component uses the output of the entity resolver to generate lists of aliases. The entity resolver maps keywords to object identifiers and outputs (keyword, object identifier) pairs to the aliasing component. The aliasing component inserts the (keyword, object identifier) pairs into lists of aliases that are stored on a storage device. The aliasing component then sorts the lists of aliases based on how frequently keywords in the lists appear in news articles or other documents, resulting in lists with the most common keywords at the top. In one embodiment, the lists are resorted based on a set of formatted object identifiers so that a preferred spelling and appearance of the keyword appears higher up on the list.

A set of aliases may be created for any Wikipedia® page. Every keyword in a given set of aliases refers to an object associated with an object identifier. For example, a set of keywords that refer to the object identified as “Elvis_Presley” may be stored in a set of aliases. The example set includes the following keywords: “elvis presley,” “elvis,” “presley,” “elvis presly,” “elvis aaron presley,” “the king of rock ‘n’ roll,” and “elvis pressly.”

Keywords may be used from a variety of sources to improve the coverage of the lists of aliases. Each keyword is sent to the entity resolver to be associated with an object identifier. The aliasing component adds the keyword to a set of aliases for the object identifier associated with the keyword. The sets of keywords, once formed, may be sorted to prioritize some keywords over others.

### Sorting Lists of Aliases

The aliasing component sorts each set, or list, of aliases so that the most popular keywords appear first. There are numerous ways to determine which keywords are the most popular. In one embodiment, keywords that are most frequently searched for in search logs are said to occur most frequently. For example, if one million people searched for “Hillary Rodham Clinton” and two million people searched for “Hillary Clintion” during a given time period (one month, for example), then “Hillary Clinton” will be listed before “Hillary Rodham Clinton” on the list. In another embodiment, the keywords most frequently occurring in news articles, blogs, and/or other Web sites are prioritized to the top of the list.

Referring to FIG. 1, aliasing component 108 searches for an alias list among lists of aliases 110 that is associated with OBJECT IDA. An alias list 111 matching OBJECT IDA is identified and sent to aliasing component 108. Aliasing component 108 searches in news articles 112 for terms from alias list 111. As shown, aliasing component 108 finds Keyword A₁ four times, Keyword A₂ three times, Keyword A₃ one time, and keyword 101 two times. Aliasing component orders alias list 111 to produce alias list 113. Alias list 113 is ordered by keyword popularity among news articles 112. Aliasing component sends ordered alias list 113 to storage device 109 to update lists of aliases 110.

Various components and data are illustrated in the figures on storage devices or in working memory. The storage arrangements shown in the figures are for illustrative purposes only and are not intended to limit the scope of the techniques described herein to store elements in any particular way. A person skilled in the art would know of several ways to store elements for implementing various techniques on a computer system or among several computer systems.

### Re-Sorting Lists of Aliases

Ordering the most popular keyword at the top of the list may provide undesirable results in some instances. For example, the keywords “receipe” and “recipe” are both in the same alias set. Users more commonly type “receipe” than “recipe” even though “recipe” is the correct spelling of the word. As a result, the misspelled word “receipe” is ordered in front of the correctly spelled word “recipe” when the keywords are ordered by popularity. As another example, “Walmart” is more commonly used than “Wal-Mart” even though “Wal-Mart” is the official name for Wal-Mart Stores, Inc.

Object identifiers, or Wikipedia® page names, may be used to re-sort the lists. Keywords in the list may be compared to the corresponding object identifier to see if any of the keywords is an exact match to the object identifier. If there is an exact match, then the matching keyword is moved to the top of the list. For example, the object identifier “Wal-Mart” is identified as the object identifier associated with a list containing the keyword “Wal-Mart”. The keyword “Wal-Mart” is moved to the top of the list.

In one embodiment, underscores are replaced by spaces and parentheticals are removed from the object identifier. For the object identifier, “Amazon_Rainforest,” the keyword “Amazon Rainforest” is searched for within the list of aliases for “Amazon_Rainforest.” The keyword “Amazon Rainforest” is detected and moved to the top of the list. In another embodiment, the matching keyword is given an additional weight that does not necessarily move the keyword to the top of the list. For example, the keyword “P. Diddy” is associated with the object identified as “Sean Combs.” However, “P. Diddy” may be a more popular keyword and, many times, may provide better search results than “Sean Combs.”

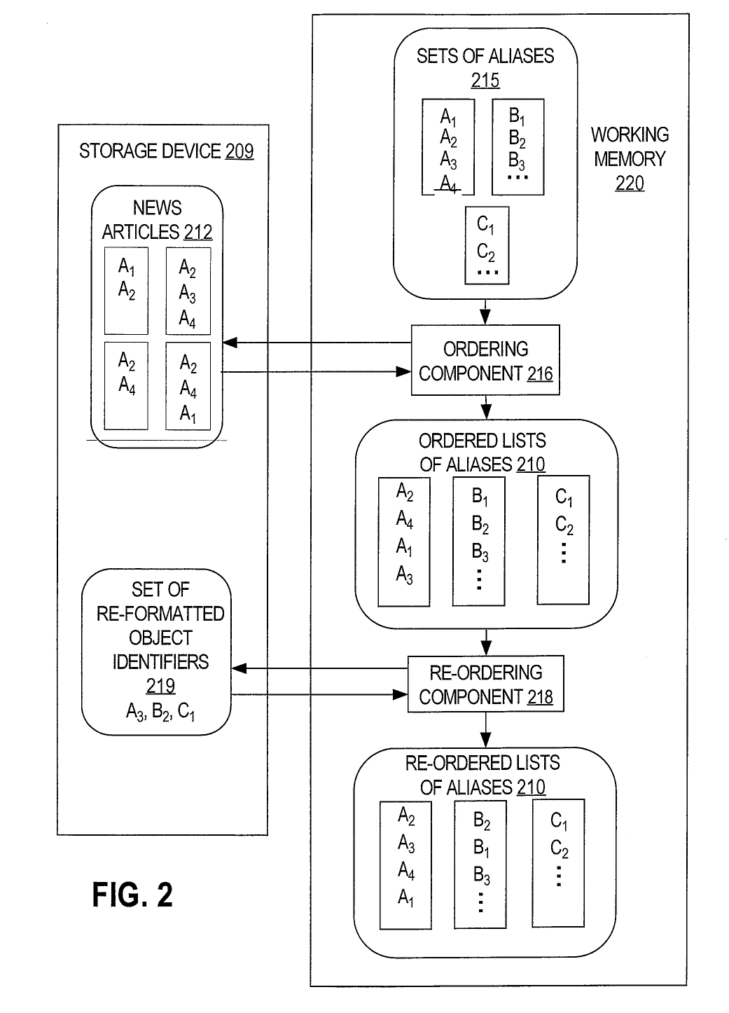

FIG. 2 shows an example system for ordering and reordering sets of aliases. Referring to FIG. 2, sets of aliases 215 are loaded into working memory 220 to be ordered. For a first set of aliases, keywords A₁, A₂, A₃, and A₄, ordering component 216 determines which keywords appear most frequently in news articles 212. News articles 212 reveal that A₁ appeared two times, A₂ appeared four times, A₃ appeared one time, and A₄ appeared three times. Accordingly, ordering component 216 generates ordered lists of aliases 210 with A₂, the most frequently occurring keyword in the first set of aliases, listed first. Similarly, the other keywords are listed in order of popularity among news articles 212, with A₃ stored last in the list.

For the first list of aliases, a re-ordering component 218 searches for the keywords A₁, A₂, A₃, and A₄ in a set of re-formatted object identifiers 219. Object identifiers may be re-formatted by removing underscores and terms in parenthesis. For example, Orange_County,_California may be reformatted as “Orange County, California” or “Orange County California.” Re-ordering component finds keyword A₃ in set of re-formatted object identifiers 219. Accordingly, re-ordering component boosts A₃ toward the top of the first list for re-ordered lists of aliases 210. As shown, keyword A₃ is stored second on the list even though the keyword matches an object identifier. In one embodiment, keywords matching object identifiers are moved to the first position in the list. In another embodiment, the matching keywords may not be moved entirely to the first position, as shown in FIG. 2.

### Resulting Lists of Aliases

Once a list of aliases have been generated, sorted, and re-sorted, the resulting list of aliases provides good keyword coverage of an object identifier with the most popular (due to sorting) and most correct (due to re-sorting) keywords appearing first.

In one embodiment, the lists of aliases include only unambiguous keywords. Accordingly, each keyword belongs to one list of aliases. Once a search provider determines to which list of aliases a keyword belongs, the search provider can stop looking for the keyword in the lists. Also, the search provider can make determinations using a single list of aliases without having to generate multiple sets of search results across multiple lists of aliases.

In another embodiment, the lists of aliases include ambiguous keywords. Some keywords may belong to more than one list of aliases. A search provider determines every list to which an alias belongs before providing results. The search provider may provide a set of results for each list of aliases. In other words, the search provider receives a query, Keyword_{X}, that refers to object identifiers ID_{Y} and ID_{Z}. If the search provider determines that Keyword_{X} is not accepted by a module, then the search provider rewrites Keyword_{X} into Keyword_{Y} and Keyword_{Z}, where Keyword_{Y} is a keyword selected from the alias list for ID_{Y}, and Keyword_{Z} is a keyword selected from the alias list for ID_{Z}. In one embodiment, the search provider prompts the user to select a rewritten query, Keyword_{Y} or Keyword_{Z}, to display. The search provider sends the selected rewritten query to the module.

In another embodiment, Keyword_{Y} and Keyword_{Z} are both sent to the module. Content generated by the module for each keyword is displayed to the user. Optionally, the user may select from content that has been generated for Keyword_{Y} or Keyword_{Z}. In response to the user selecting content for Keyword_{Y}, the search provider may remove a display of content for Keyword_{Z}, providing more space to display content for Keyword_{Y} to the user.

### Rewriting Queries

A query that is incompatible with a module may be searched for in the lists of aliases. Once the query is found in a list of aliases, the query is rewritten to the highest keyword from the list that is predicted to successfully provide content for the module. If the first keyword from the list fails to provide content for the module, then other keywords from the list of aliases may be attempted on the module until one of the keywords causes the module to successfully display content. In one embodiment, the other keywords are chosen from the highest remaining keywords that are predicted to successfully provide content for the module.

In one embodiment, a set of invalid keywords is stored for each module. When a query is received, the set of invalid keywords is searched to determine if the query is in the set. If the query is in the set of invalid keywords, then the query is rewritten. If the query is not in the set of invalid keywords, then the query may be sent to the module as is.

If the module is deterministic, which means it will always succeed or fail for any particular query, a set of common queries may be sent to the module, one by one, to determine for which queries of the set of common queries the module succeeds and for which queries the module fails.

Many modules are not deterministic. A module that could not generate content yesterday might be able to generate content today. Also, a third party module developer may not allow the search provider to test the entire set of common queries without actually providing module content to an end user.

Another way of testing the module is to use online learning and generate a model to track which queries succeed and which queries fail each time a query is sent to the module while using the system for rewriting queries. The set of invalid keywords for the system of rewriting queries is initially set to include no keywords, and this set changes over time according to the model. The model keeps track of all queries that have been sent to the module and records if the module was able to generate content for the query. If the module succeeds, indicating that the keyword successfully generated content for the module, then a successful instance of the keyword is logged.

For example, a particular module may have a success rate of 97% for the query “barack obama” but only 2% for “barack hussein obama.” The reason “barack obama” did not succeed 100% of the time may be due to time out errors or other problems on the third party server site. The reason “barack hussein obama” worked 2% (and not 0%) of the time may be due to the third party site performing a bucket test to temporarily provide results for some queries that are otherwise ignored, or due to other abnormalities from the third party site.

Collecting data while using the system for rewriting queries allows the system to constantly learn and update the set of invalid keywords for each module. In the example, the system will learn that “barack hussein obama” is not working for the module, and the system will start automatically rewriting “barack hussein obama” as “barack obama” for the module. By sending “barack obama” instead of “barack hussein obama,” the system achieves a higher overall success rate when generating content for selected modules.

The set of invalid keywords is generated for each module by testing the module with queries. Module results are tracked over time to determine keywords that frequently cause the module to fail. A threshold may be used when making a determination as to whether keywords are considered “successful” or not. A keyword that has at least a threshold (95%, for example) success rate for a particular module is identified as a keyword that is successful for the module. A keyword that generates a lower success rate (70%, for example) is identified as a keyword that is not successful for the module. In one embodiment, recent results for a module may be given more weight than old results. In one embodiment, results are only tracked within a certain window of time. For example, module results may be tracked from a month ago until yesterday.

If a query or keyword is in the set of invalid keywords, then the query is presumed to be incompatible with the module. The query need not be sent to the module. In one embodiment, a sample set of queries presumed to be incompatible with the module are sent to the module in order to provide updated statistics on module results.

Once it has been determined that a query or keyword is incompatible with the module, the query may be searched for in the lists of aliases. If the query is not found in a list of aliases, then the query is not rewritten. Alternately, the query may be sent to the entity resolver component to determine to which object identifier or object identifiers the query is most closely associated.

If the query is found in the list of aliases, then the query is rewritten to the top keyword on the list that is predicted to be compatible with the module. For example, if the query is the third keyword in the list, then the first keyword is examined to determine whether the first keyword is compatible with the module. In one embodiment, the first keyword is searched for in the set of invalid keywords.

If the first keyword is found in the set of invalid keywords, then the second keyword is searched for in the set of invalid keywords. If the second keyword is found in the set of invalid keywords, then the fourth keyword is searched for in the set of invalid keywords, and so on. If the second keyword is not found in the set of invalid keywords, then the second keyword is sent to the module, replacing the query.

If the first keyword is not found in the set of invalid keywords, then the first keyword is sent to the module, replacing the query. The module provides content for the received compatible keyword. The content provided by the module is likely to be associated with the object identified by the alias list containing the query.

In another embodiment, the list of aliases contains a record, for each keyword, of the keyword's compatibility with a set of modules. Each keyword may be compatible with some modules but not others. Some keywords may be compatible with all modules, and some keywords may be compatible with no modules. For example, the keyword “YHOO” may be compatible with modules providing finance content but not modules providing sports content. The keyword “Michael Phelps” may be compatible with modules providing sports content but not modules providing finance content. As another example, the keyword “Supercalifragilisticexpialidocious” may or may not be compatible with any modules even though the keyword is identified as an object in Wikipedia®.

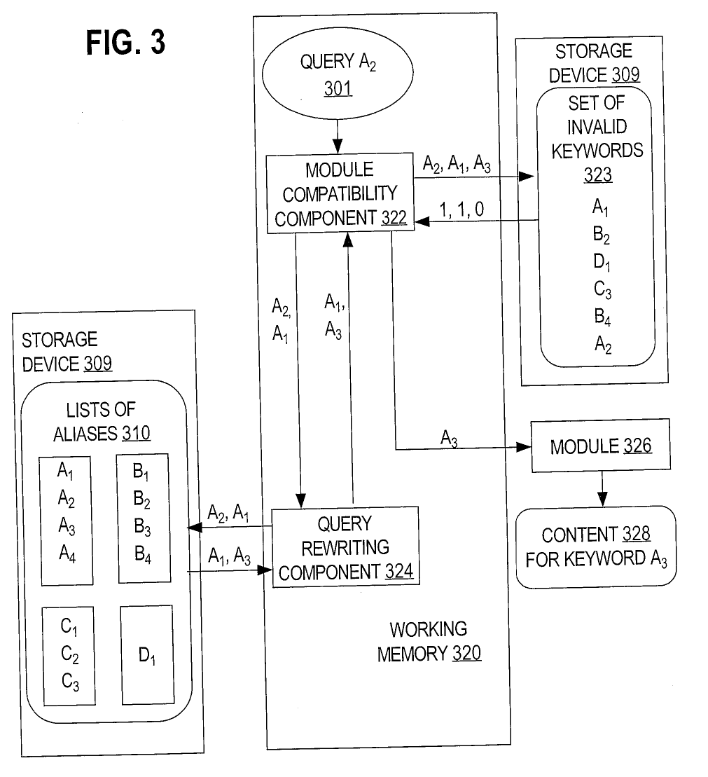

FIG. 3 shows a system for rewriting a query 301 (keyword A₂). Module compatibility component receives query 301 and determines whether query 301 exists among a set of invalid keywords 323, shown on storage device 309. Module compatibility component searches for A₂, indicated by the “A₂” shown first above the arrow between module compatibility component 322 and set of invalid keywords 323. Set of keywords 323 contains keyword A₂ and indicates to module compatibility component 322 that A₂ is in set of keywords 323, shown as a “1” above the arrow between set of keywords 323 and module compatibility component 322.

Because keyword A₂ is not valid for module 326, module compatibility component 322 sends keyword A₂ to query rewriting component 324. Query rewriting component 324 searches for keyword A₂ among lists of aliases 310, indicated by the “A₂” above the arrow from query rewriting component 324 to lists of aliases 310. Keyword A₂ is found in the first list of aliases, as shown, and the top keyword from the first list, “A₁,” is returned to query rewriting component 324. Query rewriting component 324 sends keyword A₁ to module compatibility component 322. Module compatibility component 322 determines from set of invalid keywords 323 that A₁ is also in set of invalid keywords 323, indicated by the second “1” in the arrow from set of invalid keywords 323 to module compatibility component 322.

Module compatibility component sends keyword A₁ to query rewriting component 324 so that query A₁ may be rewritten. Query rewriting component 324 searches for A₁ in lists of aliases 310. Alternately, query rewriting component 324 recalls the first list of lists 310 from the previous attempt. Keyword A₃ appears next among the keywords in the first list that have yet to be attempted. Query rewriting component sends keyword A₃ to module compatibility component, which determines that keyword A₃ is not in set of invalid keywords 323, indicated by the 0 above the arrow between set of invalid keywords 323 and module compatibility component 322. Module compatibility component sends keyword A₃ to module 326. Module 326 generates content 328 for keyword A₃.

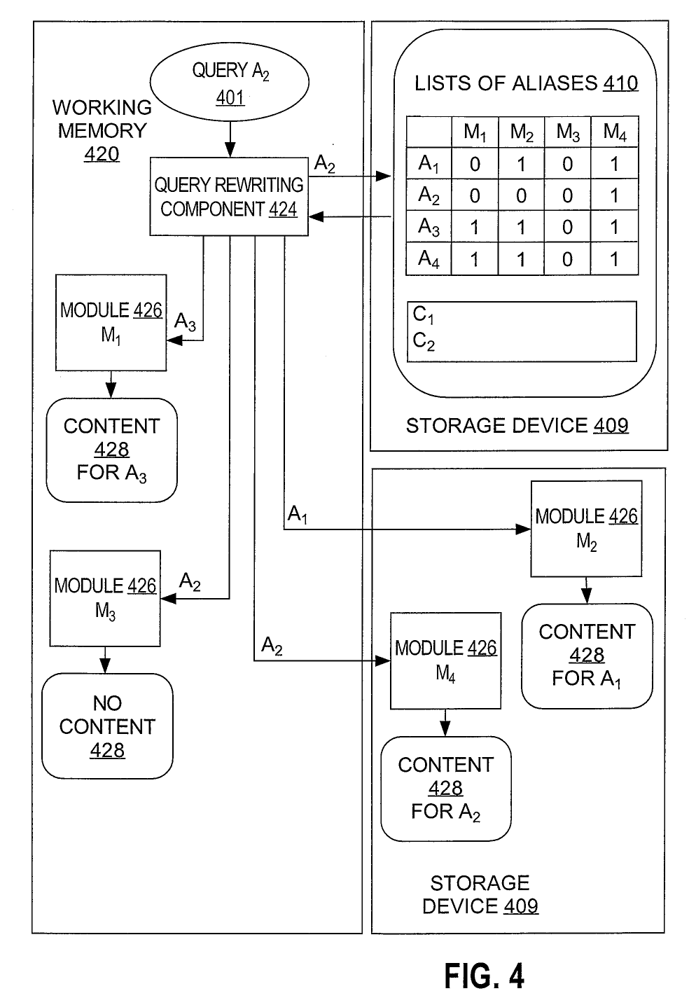

FIG. 4 shows an alternate system for determining whether a query is compatible with a module. Query 401 (keyword A₂) is sent to query rewriting component 424 of a search provider. The search provider searches for A₂ among lists of aliases 410. As shown in FIG. 4, lists of aliases contain module compatibility data that indicates whether a given keyword is accepted by a module. Here, the data for each keyword is stored in a simple true/false format for each module. In other embodiments, the data may be stored as counts of successful and unsuccessful attempts for each module. According to the first list of aliases of lists of aliases 410, keyword A₂ is not compatible with any modules except for module (item 426) M₄. Query rewriting component 424 may send module (item 426) M₄ query A₂ (item 401) without rewriting query A₂. Module M₄ generates content for A₂, which can be displayed by the search provider on a search results page.

The first list of aliases in lists of aliases 410 shows that keyword A₁, which is at the top of the first list, is compatible with module M₂. Query rewriting component 424 rewrites query A₂ (item 401) into keyword A₁. Query rewriting component sends keyword A₁ to module M₂. Module M₂ generates content for keyword A₁, which can be displayed by the search provider on a search results page that is viewed by a user who typed in query A₂.

The first list of aliases shows that keyword A₃, which is next highest after A₁ and A₂ on the first list, is compatible with module M₁. Query rewriting component 424 rewrites query A₂ (item 401) into keyword A₃. Query rewriting component sends keyword A₃ to module M₁. Module M₁ generates content for keyword A₃, which can be displayed by the search provider on a search results page that is viewed by a user who typed in query A₂.

Finally, the first list of aliases shows that no keywords are compatible with module M₃. In the embodiment shown, original query 401 is sent to module (item 426) M₃ to display content. Because M₃ is not compatible with A₂, module M₃ (item 426) fails to display content, indicated by no content item 428.

In another example, module M₃ is able to display content despite the prediction from module compatibility data in lists of aliases 410. If keyword A₂ succeeds on module M₃, a learning model could be updated with new data that indicates keyword A₂ succeeded in one instance on module M₃. If keyword A₂ succeeds enough times, then the learning model will update the module compatibility data stored in lists of aliases 410 to reflect that keyword A₂ is accepted by module M₃.

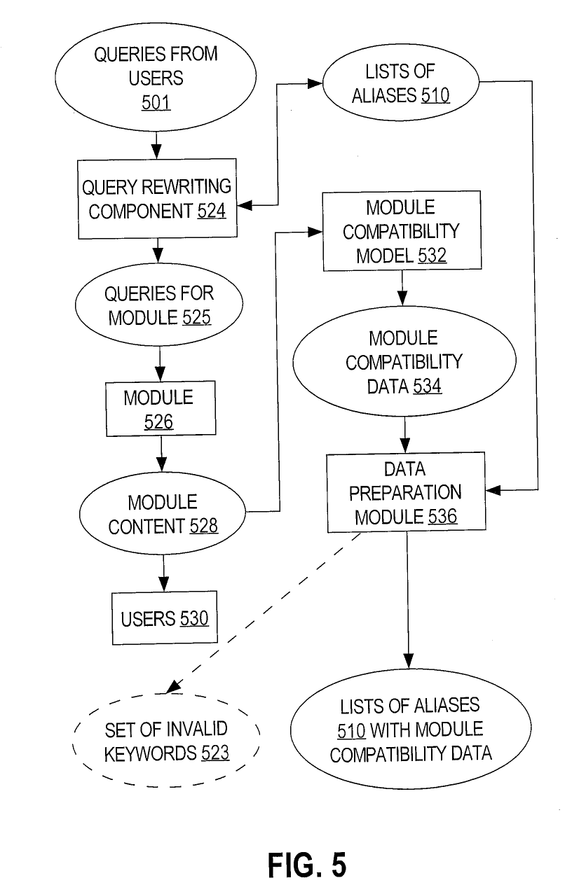

FIG. 5 shows a system for updating lists of aliases 510 with module compatibility data. Queries 501 are received by a search provider from users. Query rewriting component 524 determines whether to rewrite queries 501, rewriting if necessary using lists of aliases 510. Query rewriting component 524 produces queries for a module, item 525, which may or may not be rewritten depending on lists of aliases 510 and module compatibility data that already exists in the system.

Module 526 receives queries 525 and generates module content 528. Module content 528 is sent to users 530 and to module compatibility model 532. Module compatibility model stores module compatibility data 534 that indicates which modules 526 that queries 501 are successful for, and which modules 526 that queries 501 are unsuccessful for. Data preparation module 536 receives module compatibility data 534 and incorporates module compatibility data 534 into lists of aliases 510 or into set of invalid keywords 523.

### Providing Content

Many content providers are designed to provide content for keywords. For example, on YouTube®, a user types in a keyword and receives content in the form of videos. On Wikipedia®, a user types in a keyword and receives content in the form of information about the keyword. Some modules provide special content for specific keywords. For example, hot keywords like “electronics” and “books” may be reserved to provide content featured by advertisers.

A search provider may provide content from a variety of modules for a given query. For example, a query for “yahoo” may cause a search provider to display a result page that contains a mash up of data such as pictures, videos, articles, links, music, maps, etc. related to the query “yahoo.”

A search provider may rewrite queries to provide content based on the object to which the original query is associated. For example, a query for “yahoo” is associated with an object identified as “Yahoo!” and rewritten to “YHOO” for a finance module, “Yahoo, Inc.” for a business news module, and “Yahoo” for a general news module. The results for each module may be displayed in various regions of the screen. In one embodiment, the content is arranged by media type such as picture, video, audio, or text. In another embodiment, the content is arranged by source, such as CNN®, ESPN®, or Wikipedia®. An example results page shows a Wikipedia® module displaying some text and one image from Wikipedia®, a news module displaying links to news articles, and a sponsored module displaying sponsored links.

In yet another embodiment, the content is arranged by object identifier. Ambiguous queries may be rewritten to multiple other queries using the techniques described herein. The multiple other queries may be used to generate content, which can be displayed on the screen to the user with a region for each object identifier to which the ambiguous keyword may refer. The user is given an option to select one or more of the regions for which the user wishes to see more content. For example, a search for “amazon” may produce content for objects identified as “Amazon.com” and “Amazon_Rainforest.” Content may be arranged on the screen so that the user may select to see more information about either “Amazon.com” or “Amazon_Rainforest.”

In one embodiment, a particular module may be reserved for an object identifier. For example, BestBuy®, a popular computer and electronics store, may reserve a module to be displayed when the user searches for an object identified as “Computer” or “Electronics.” Incompatible queries may be rewritten to a keyword compatible with the BestBuy.com module. In this manner, companies may reserve objects instead of keywords for advertising purposes.

In another embodiment, a particular keyword may be reserved for an object identifier. For example, a particular keyword such as “Amazon.com” can be moved to the top of the list of aliases for “Book.” If the user searches for “book,” then the query may be rewritten as “Amazon.com,” which is an online bookseller. Alternately, the query may be appended with “Amazon.com” so that the query is rewritten as “book Amazon.com.”

### Selecting a Module Matching an Object Category

The Yet Another Great Ontology (YAGO) system is discussed in this application as a system for categorizing object identifiers. A more detailed description of creation, maintenance, and use of the YAGO ontology is available in Suchanek, F. M., Kasneci, G. & Weikum, G., “YAGO: A Core of Semantic Knowledge—Unifying WordNet and Wikipedia®,” The 16th International World Wide Web Conference, Semantic Web: Ontologies Published by the Max Planck Institut Informatik, Saarbrucken, Germany, Europe (May 2007), the entire contents of which is hereby incorporated by reference as if fully set forth herein.

The Yet Another Great Ontology (YAGO) system can be used as classifier to map an object identifier to an entity category. The YAGO ontology is accessible through a URL. Alternately, the YAGO ontology can be downloaded for more efficient and reliable access. The YAGO ontology categorizes Wikipedia page names, or object identifiers.

The YAGO ontology utilizes Wikipedia® category pages, which list Wikipedia® object identifiers that belong to the category pages. For example, “The_Dark_Knight” can be identified as a film because it belongs to the “2008_in_film” category page. In YAGO, the Wikipedia® categories, like other object identifiers, are stored as entities. A relationship is created between non-category Wikipedia® entities (“individuals”) and category Wikipedia® entities (“classes”). For example, YAGO stores an entity, relation, entity triple (“fact”) as follows: “The_Dark_Knight TYPE film.” Wikipedia® categories alone do not yet provide a sufficient basis for a well-structured ontology because the Wikipedia® categories are organized based on themes, not based on logical relationships. See Suchanek, et al.

Unlike Wikipedia®, WordNet® provides an accurate and logically structured hierarchy of concepts (“synsets”). A synset is a set of words with the same meaning. WordNet® provides a hierarchical structure among synsets where some synsets are sub-concepts of other synsets. WorldNet® is accurate because it is carefully developed and edited by human beings for the purpose of developing a hierarchy of concepts for the English language. Wikipedia®, on the other hand, is developed through a wide variety of humans with various underlying goals. See Suchanek, et al.

To take advantage of the hierarchical structure in WordNet®, the YAGO ontology maps Wikipedia® categories to YAGO classes. Various techniques for mapping Wikipedia® categories to YAGO classes are described in Suchanek, et al. In one embodiment, the YAGO ontology exploits the Wikipedia® category names. Wikipedia® category names are broken down into a pre-modifier, a head, and a post-modifier. For example, “2008 in film” would be broken down into “2008 in” (pre-modifier) and “film” (head). If WordNet® contains a synset for the pre-modifier and head, then the synset is related to the category. If not, a synset related to the head is related to the category. If there is no synset that matches the pre-modifier and head or the head alone, then the Wikipedia® category is not related to a WordNet® synset. In the example, the head of the category matches the synset “film” as follows: “2008 in film TYPE film.” By classifying “2008 in film” as “film,” YAGO can determine that “The_Dark_Knight_(2008)” is a “film.”

In one embodiment, an object ID is mapped to more than one category. For example, “The_Dark_Knight_(2008)” may be categorized under “film” and “superhero.” Optionally, a separate annotated query may be generated for each category. In another embodiment, the entity categories can be combined into a entity category placeholder that refers to both entities. The placeholder may, for example, be of the form:
<<film><superhero>>. In yet another embodiment, the least common or worst fitting category is ignored. If, for example, the classifier is 70% sure that
“The_Dark_Knight_(2008)” fits under “superhero” and 80% sure that
“The_Dark_Knight_(2008)” fits under “film,” then “film” is used as the category.

In one embodiment, the search provider selects a module or modules to display based at least in part on object category. The search provider may store a list of modules and module categories that are associated with those modules. For example, an ESPN® module is stored under the “sports” category. The search provider determines the object identifiers that are associated with the query. For example, the query “phelps gold” is associated with the object identified as “Michael_phelps.” Object categories for the object identifiers are provided by a classifier. In the example, the object “Michael_phelps” is classified under “sports” or “athletes.”

The search provider then compares the object categories with the module categories to determine which modules to display. The search provider selects modules in module categories that are most closely associated with the object categories. In one embodiment, a mapping between module categories and object categories is generated by an administrator for the search provider. In the “phelps gold” example, an ESPN® module may be selected, and either the query “phelps gold” or “Michael Phelps,” which is extracted from a list of aliases for “Michael_phelps,” is sent to the ESPN® module.

In one example, a query such as “britney spears” is mapped to the object identified as “Britney_Spears,” which fits in a Celebrity category. A module such as a YouTube® video module is associated with the celebrity category, and the YouTube® video module is selected for displaying content for the query “britney spears.”

In another embodiment, the mapping is generated based on statistical information about modules that receive the most user input for objects from particular objects categories. Based on the statistical information, modules that receive a high amount of user input for a particular object category are placed in a module category that corresponds to the object category. Machine learning techniques can be used to maintain a continually updated list of module categories.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

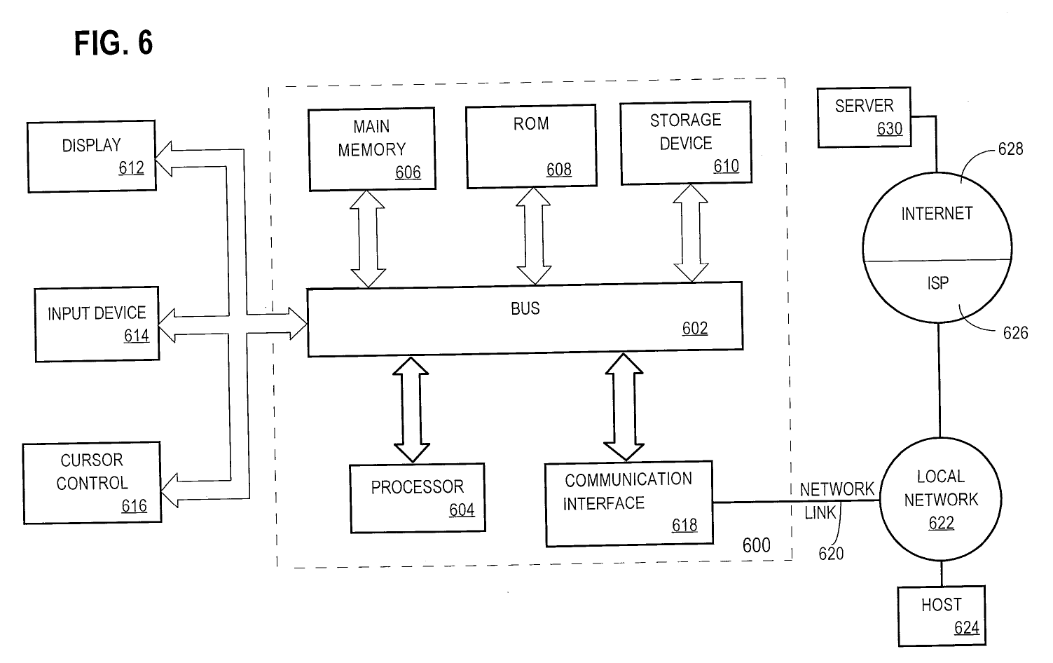

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
receiving a query that maps to an object identifier;
determining that the query is not compatible with a module;
determining that a keyword maps to the object identifier; and
transforming the query into the keyword.

2. The computer-implemented method of claim 1, wherein said module is a particular module, further comprising:
selecting said particular module based at least in part on said object identifier.

3. The computer-implemented method of claim 1, wherein the step of determining that the keyword maps to the object identifier comprises determining that the keyword is a particular keyword that has been reserved for use with said object identifier.

4. A computer-implemented method comprising:
receiving a first keyword;
determining that the first keyword is not compatible with a module;
locating the first keyword in a set of keywords, the set of keywords stored on a volatile or non-volatile computer-readable storage medium;
wherein each keyword of the set of keywords is associated with an object identifier;
determining that a second keyword is in the set of keywords; and
querying the module with the second keyword.

5. The computer-implemented method of claim 4, further comprising:
determining that the second keyword is compatible with the module.

6. The computer-implemented method of claim 4, further comprising:
storing a frequency by which the module generates content when queried with the first keyword; and
wherein the step of determining that the first keyword is not compatible with the module is based at least in part on the frequency.

7. The computer-implemented method of claim 4, wherein the step of determining that the first keyword is not compatible with the module comprises:
querying the module with the first keyword; and
determining that the module failed to provide content for the first keyword.

8. The computer-implemented method of claim 4, wherein the object identifier is generated from a user-managed encyclopedia of objects.

9. The computer-implemented method of claim 4, wherein, in response to the step of querying, the module provides content for a display.

10. The computer-implemented method of claim 9, further comprising storing information that indicates that the second keyword is compatible with the module.

11. The computer-implemented method of claim 4,
wherein the, in response to the step of querying, the module fails to provide content for the second keyword;
further comprising storing information that indicates that the second keyword is not compatible with the module.

12. The computer-implemented method of claim 4, wherein the set of keywords is a list of keywords that is ordered to prioritize keywords in the list that frequently occur in a set of documents.

13. The computer-implemented method of claim 12, wherein documents of the set of documents are one or more types selected from the group consisting of:
news articles,
query logs,
blogs, and
other Web sites.

14. The computer-implemented method of claim 4,
wherein the set of keywords is a list of keywords that contains an object keyword derived from an object identifier;
further comprising ordering each list to prioritize the object keyword.

15. The computer-implemented method of claim 4, wherein the set of keywords is a first set of keywords and the object identifier is a first object identifier, further comprising:
locating the first keyword in a second set of keywords, the second set of keywords stored on the volatile or non-volatile computer-readable storage medium;
wherein each keyword of the second set of keywords is associated with a second object identifier; and
determining a third keyword of the second set of keywords.

16. The computer-implemented method of claim 15, further comprising:
sending the second keyword and the third keyword to a user;
receiving a selection from the user; and
wherein said step of querying the module is based at least in part on the selection.

17. The computer-implemented method of claim 15, further comprising:
querying the module with the third keyword.

18. The computer-implemented method of claim 17,
wherein in response to querying the module with the second keyword, the module provides a first content for a display;
wherein in response to querying the module with the third keyword, the module provides a second content for a display;
receiving a selection comprising the first content; and
removing the second content from the display.

19. A computer-implemented method comprising:
generating a set of keywords;
removing keywords from the set of keywords that are not associated with an object identifier with a minimum degree of confidence;
receiving a query;
determining that the query is not compatible with a module;
locating the query in the set of keywords; and
rewriting the query to a keyword in the set of keywords that is associated with the same object identifier as the query.

20. The computer-implemented method of claim 19, further comprising:
for each keyword of the set of keywords, normalizing a degree of confidence between the keyword and one or more object identifiers;
wherein the step of removing keywords comprises removing keywords with a normalized degree of confidence that does not meet the minimum degree of confidence.

21. The computer-implemented method of claim 19, further comprising:
for each keyword of the set of keywords, determining a degree of confidence between the keyword and one or more object identifiers, the degree of confidence for each object identifier based at least in part on a frequency by the keyword is used to locate documents associated with the object identifier;
wherein the step of removing keywords comprises removing keywords with a degree of confidence that does not meet the minimum degree of confidence.

22. A volatile or non-volatile computer-readable storage medium storing one or more sequences of instructions which, when executed by one or more processors, cause the one or more processors to perform the steps recited in claim 1.

23. A volatile or non-volatile computer-readable storage medium storing one or more sequences of instructions which, when executed by one or more processors, cause the one or more processors to perform the steps recited in claim 4.

24. A volatile or non-volatile computer-readable storage medium storing one or more sequences of instructions which, when executed by one or more processors, cause the one or more processors to perform the steps recited in claim 19.
